(19) United States
(12) Patent Application Publication
(10) Pub. No.: US 2025/0019548 A1
(43) Pub. Date: Jan. 16, 2025

(54) BIPHASIC ANTI-ICING COATING FOR SENSORS AND BODY COMPONENTS OF VEHICLES

(71) Applicant: GM Global Technology Operations LLC, Detroit, MI (US)

(72) Inventors: Adam F. Gross, Malibu, CA (US); Anthony L. Smith, Troy, MI (US); Michael D. Alarcon, Markham (CA); Ratandeep Singh Kukreja, Auburn Hills, MI (US); Dayananda Narasimhaiah, Franklin, MI (US); April R. Rodriguez, Los Angeles, CA (US); Ashley Dustin, Santa Monica, CA (US); Andrew P. Nowak, Winnetka, CA (US); Michael Jared Ventuleth, Camarillo, CA (US)

(21) Appl. No.: 18/351,787

(22) Filed: Jul. 13, 2023

(51) Int. Cl. C09D 5/02; C09D 7/61; C09D 7/63; C09D 7/65; C09D 123/08; C09D 123/28

(52) U.S. Cl. CPC C09D 5/024; C09D 7/61; C09D 7/63; C09D 7/65; C09D 123/0892; C09D 123/283

(57) ABSTRACT

An anti-icing coating having a continuous phase and a discrete phase. The continuous phase includes a fluorine-containing polymer formed from a fluorine-containing precursor having a functionality of greater than 2. The discrete phase includes a plurality of domains having a fluorine-free hygroscopic and/or hydrophilic material. The plurality of domains are dispersed within the continuous phase and are immersible with the continuous phase. At least a portion of the fluorine-free material is bonded to the fluorine-containing polymer with an isocyanate-containing moiety. The fluorine-containing polymer is crosslinked with a crosslinking molecule having at least 4 functional groups. The fluorine-free material is a poly(ethylene glycol).

### INTRODUCTION

The present disclosure relates to coatings for exterior surfaces of vehicles, more particularly to anti-icing coatings for exterior sensors and body components of vehicles.

Modern vehicles, especially those of partial to full autonomous vehicles, are equipped with exterior sensors that gather information on the surroundings of the vehicles. Radio detection and range (RADAR), light detection and range (LiDAR), ultrasonic, and cameras represent the majority of exterior sensors used in the automotive industry. These exterior sensors are typically mounted on exterior surfaces or pockets defined in exterior panels of the vehicles. The exterior surfaces of the vehicle sensors and vehicle components are formed of various materials including plastics, metals, sensors, glass, and painted surfaces that are susceptible to the harsh external operating environments of the vehicle.

Road debris including dirt, dust, solvents including oils and fuels, as well as water, sleet, ice, and snow under freezing conditions, accumulate on the exterior surfaces of the sensors and components. The accumulations not only affect the aesthetics of the sensors and components, but also the performance of these sensors and operational surfaces. Particularly in operating environments below freezing temperatures, ice, sleet, and snow may accumulate on the exterior surfaces of these sensors, potentially affecting the operations of these sensors as well as moveable exterior components such as fuel doors, charging ports, hoods, and trunk lids.

Anti-debris coatings have been applied to the exterior surfaces of the sensors and vehicle components. However, known anti-debris coatings have limited effectiveness on ice formations and a limited effective life that may be prematurely shortened due to solvents such as oil and fuel that may contaminate the surfaces of the anti-debris coatings. Thus, while known anti-debris coatings achieve their intended purpose, there is a continued need for an improved or new coating that has improved anti-icing capabilities, resistance to solvents, and withstand the harsh operating environments of vehicles.

### SUMMARY

According to several aspects, an anti-icing coating having a continuous phase including a first material and a plurality of domains including a second material is disclosed. The plurality of domains are dispersed within the continuous phase and are immersible with the continuous phase. One of the first material and the second material includes a fluorine-containing polymer formed from a fluorine-containing precursor having a functionality of greater than 2. The other of the first material and the second material includes a fluorine-free hygroscopic or hydrophilic material. At least a portion of the fluorine-free material is bonded to the fluorine-containing polymer with an isocyanate-containing moiety. The fluorine-containing polymer is crosslinked with a crosslinking molecule having at least 4 functional groups including a nitrogen-containing moiety, an oxygen-containing moiety, and a combination thereof.

In an additional aspect of the present disclosure, the first material is the fluorine-containing polymer and the second material is the fluorine-free material.

In another aspect of the present disclosure, the fluorine-free material includes at least one of a poly(acrylic acid), a poly(ethylene glycol), a poly(2-hydroxyethyl methacrylate), a poly(vinyl imidazole), a poly(2-methyl-2-oxazoline), a poly(2-ethyl-2-oxazoline), a poly(vinylpyrolidone), and a modified cellulosic polymers including at least one of a carboxymethyl cellulose, a hydroxyethyl cellulose, a hydroxypropyl cellulose, and a methyl cellulose.

In another aspect of the present disclosure, the fluorine-free material is a poly(ethylene glycol).

In another aspect of the present disclosure, the fluorine-containing polymer includes at least one of a fluorinated polyol, a perfluorocarbon, a perfluoropolyether, polyfluoroacrylate, polyfluorosiloxane, a polyvinylidene fluoride, a polytrifluoroethlylene, a polytetrafluoroethylene, and copolymers thereof.

In another aspect of the present disclosure, the fluorine-containing precursor includes at least one of a hydroxyl and amine functional groups.

In another aspect of the present disclosure, the fluorine-containing precursor is a polytetrafluoroethylene having a plurality of pendant hydroxyl groups.

In another aspect of the present disclosure, the anti-icing coating further includes at least one ionic species selected from the group consisting of (2,2-bis-(1-(1-methyl imidazolium)-methylpropane-1,3-diol bromide), 1,2-bis(2′-hydroxyethyl)imidazolium bromide, (3-hydroxy-2-(hydroxymethyl)-2-methylpropyl)-3-methyl-1H-3λ4-imidazol-1-ium bromide, 2,2-bis(hydroxymethyl)butyric acid, N,N-bis(2-hydroxyethyl)-2-aminoethanesulfonic acid, N-methyl-2,2′-iminodiethanol, 3-dimethylamino-1,2-propanediol, 2,2-bis(hydroxymethyl)propionic acid, 1,4-bis(2-hydroxyethyl)piperazine, 2,6-diaminocaproic acid, N,N-bis(2-hydroxyethyl)glycine, 2-hydroxypropanoic acid hemicalsium salt, dimethylolpropionic acid, N-methyldiethanolamine, N-ethyldiethanolamine, N-propyldiethanolamine, N-benzyldiethanolamine, N-t-butyldiethanolamine, bis(2-hydroxyethyl) benzylamine, and bis(2-hydroxypropyl) aniline.

In another aspect of the present disclosure, the anti-icing coating further includes at least one ionic species polymerized by the isocyanate-containing moiety at the same time as both the fluorine-containing polymer and the fluorine-free material, thus the at least one ionic species is between the fluorine-containing polymer and the fluorine-free material.

In another aspect of the present disclosure, the plurality of domains has an average size of greater than or equal to about 100 nm to less than or equal to about 5,000 nm.

According to several aspects, an anti-icing coated applique is disclosed. The applique includes a polymer film having an external surface and an internal surface opposite the external surface, a pressure sensitive adhesive applied to the internal surface, and an anti-icing coating applied to the external surface. The anti-icing coating includes a continuous phase having a fluorine-containing polymer having a functionality of greater than 2, a plurality of domains having a fluorine-free material, and a crosslinking molecule with 4 or more functional groups bonding a portion of the fluorine-containing polymer to a portion of the fluorine-free material through at least one of a di-isocyanate containing moiety and a tri-isocyanate containing moiety. The plurality of domains are dispersed within the continuous phase and are immiscible with the fluorine-containing polymer.

In an additional aspect of the present disclosure, the crosslinking molecule comprises a nitrogen-containing moiety, an oxygen-containing moiety, and a combination thereof.

In another aspect of the present disclosure, the crosslinking molecule is a pentaerythritol propoxylate.

In another aspect of the present disclosure, the anti-icing coating further comprises 0.5-5 wt. % of colloidal silica.

In another aspect of the present disclosure, the anti-icing coating further comprises at least one of an antioxidant, a hindered amine stabilizer.

According to several aspects, an anti-icing coating for a vehicle component. The anti-icing coating includes a continuous phase having a fluorine-containing polymer formed from a fluorine-containing precursor having a functionality of greater than 2 and a plurality of domains having a fluorine-free material is disclosed. The plurality of domains are dispersed within the continuous phase and are immersible with the continuous phase. At least a portion of the fluorine-free material is bonded to the fluorine-containing polymer with an isocyanate-containing moiety. The fluorine-containing polymer is crosslinked with a crosslinking molecule having at least 4 functional groups including a nitrogen-containing moiety, an oxygen-containing moiety, and a combination thereof.

In an additional aspect of the present disclosure, the fluorine-containing precursor comprises a fluorinated material having at having at least one of a hydroxyl group and an amine group. The fluorinated material includes at least one of a fluorinated polyol, a perfluorocarbon, a perfluoropolyether, a polyfluoroacrylate, a polyfluorosiloxane, a polyvinylidene fluoride, a polytrifluoroethlylene, and a polytetrafluoroethylene.

In another aspect of the present disclosure, the fluorine-free material comprises at least one of a poly(acrylic acid), a poly(ethylene glycol), a poly(2-hydroxyethyl methacrylate), a poly(vinyl imidazole), a poly(2-methyl-2-oxazoline), a poly(2-ethyl-2-oxazoline), and a poly(vinylpyrolidone), and a modified cellulosic polymer including at least one of a carboxymethyl cellulose, a hydroxyethyl cellulose, a hydroxypropyl cellulose, and a methyl cellulose.

In another aspect of the present disclosure, the fluorine-free material is a poly(ethylene glycol).

In another aspect of the present disclosure, the anti-icing coating is applied on an exterior surface of a vehicle component.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a functional diagram of a vehicle equipped with a detection system, according to an exemplary embodiment;

FIG. 2 is a schematic illustrating a surface of an article coated with a biphasic anti-icing coating of the present disclosure, according to an exemplary embodiment;

FIGS. 3A-3C are laser scanning confocal microscope images of the biphasic anti-icing coating, according to an exemplary embodiment; and

FIG. 4 is an illustration of an applique having the biphasic anti-icing, according to an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

As used herein, a module or control module means any one or various combinations of one or more processors, associated memory, and other components operable to execute a software, firmware, program, instruction, routine, code, and algorithm to provide the described functions. Processors include, but are not limited to, Application Specific Integrated Circuits (ASIC), electronic circuits, central processing units, microprocessors, and microcontrollers. Associated memory includes, but not limited to, read only memory (ROM), random access memory (RAM), and electrically programmable read only memory (EPROM). Functions of a control module as set forth in this disclosure may be performed in a distributed control architecture among several networked control modules. A control module may include a variety of communication interfaces including point-to-point or discrete lines and wired or wireless interfaces to other control modules.

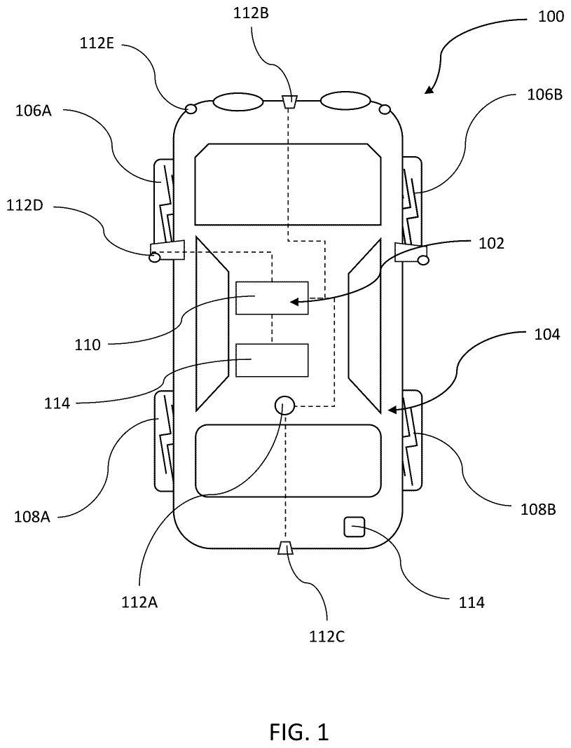

FIG. 1 shows a functional diagram of a non-limiting exemplary vehicle 100 equipped with a detection system 102. The vehicle 100 generally includes a body 104 having front wheels 106A, 106B and rear wheels 108A, 108B. The front wheels 106A, 106B and the rear wheels 108A, 108B are each rotationally located near a respective corner of the body 104. The detection system 102 includes a detection module 110 in communications with a plurality of external sensors 112A-112E including, but not limited to, optical laser devices such as a Light Detection and Ranging (LIDAR) device 112A for having 360 degrees of view about the vehicle 100, a forward viewing camera 112B, a rearward viewing camera 112C, a sideview camera 112D, and a range sensor 112E such as a sonar device.

One or more of the exterior sensors 112A-112E may be equipped with localized processing components which process gathered data. The processed data or raw sensor data may be communicated directly to the detection module 110 for further processing. The processed data may be communicated to an advanced driver-assistance system (ADAS) module 114 to enhance operator awareness such as activating a driver warning interface or enhancing vehicle operations in accordance with SAE J3016 Levels of Driving Automation.

For optimal detection of the external surroundings of the vehicles, the detection surfaces of the sensors 112A-112E should be free of debris as much as possible. In wet and freezing operating environments, liquid water may infiltrate the mounting surfaces of the sensors 112A-112E and the vehicle body 104, as well as wetting the external surfaces of the sensors 112A-112E. As the liquid water freezes on the sensor surfaces, ice formation may have an undesirable impact on the operating parameters of the sensors. Similarly, water and sleet may infiltrate moveable panels of the vehicle 100, such as the gas door/charging port 114, and freeze, thereby causing these moveable panels to be temporarily inoperable.

The present disclosure provides a biphasic anti-icing coating having improved durability, improved adhesion to the surfaces of the exterior sensors and panels, and improved resistant to solvents such as oil and fuel as compared to known anti-debris coatings. The instant biphasic anti-icing coasting, also referred to as the anti-icing coating, contains two chemically distinct materials including a fluorinated material and a non-fluorinated (fluorine-free) anti-freeze material. The biphasic anti-icing coating inhibits wetting and the freezing of water on the surfaces of the sensors and body components of vehicles to ensure proper operations of these sensors and body components. As used herein, the terms “composition”, “chemistry”, and “material” are used interchangeably to refer broadly to a substance containing at least the preferred chemical constituents, elements, or compounds, but which may also comprise additional elements, compounds, or substances, including trace amounts of impurities, unless otherwise indicated.

The controlled phase separation of the two chemically distinct materials enables both chemically distinct materials to be in contact with ice and inhibits the wetting of water and the formation of ice on the coated surfaces. The combination of non-miscible chemical functions and controlled phase separation of the anti-icing coating is achieved by using a fluorinated material precursor, such as a branched fluorinated polyol, that is capable of producing a highly crosslinked network due to the high level of hydroxyl groups found throughout the backbone of the fluorinated polymer and a crosslinking molecule with four (4) or more functional groups.

Prior art teaches that increased crosslinking decreases icephobic performance of a coating (Kevin Golovin et al., Designing durable icephobic surfaces. Sci. Adv. 2, e1501496(2016).

DOI:10.1126/sciadv.1501496). In contrast, the instant anti-icing coating has a highly crosslinked network by spreading the crosslinking along a fluorinated polyol. The highly crosslinked network of the instant anti-icing coating does not create crystalline regions that results in a hard coating that cannot break away ice formations. The branched fluorinated polyol and crosslinking molecule with four (4) or more functional groups functions synergistically to resist water and stop the infiltration of ice while resisting solvents such as oils and fuels that is commonly encountered on roadways. The fluorinated polymer phase rejects water, while the non-fluorinated solid anti-freeze material prevents ice from forming.

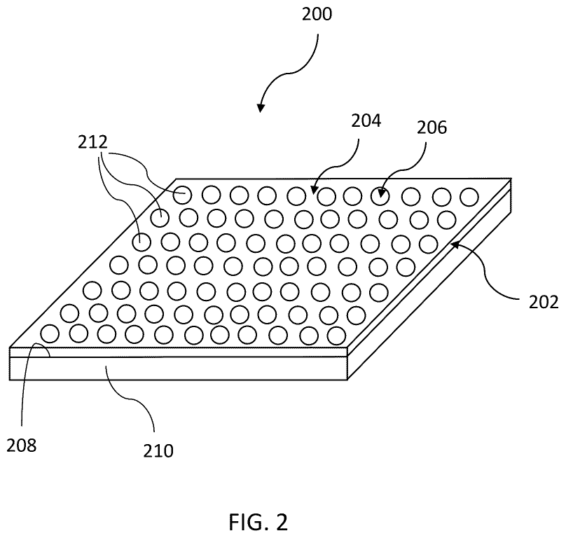

FIG. 2 shows a portion of a coated article 200 having the biphasic anti-icing coating 202 that has a continuous phase 204 and a discrete phase 206. The biphasic anti-icing coating 202 is disposed on a surface 208 of an article 210 and thus provides anti-icing and anti-wetting properties to the article 210. The discrete phase 206 defines a plurality of domains 212 having an average size of greater than or equal to about 100 nm to less than or equal to about 5,000 nm. It should be appreciated that FIG. 2 is merely an illustrative simplified schematic and is not to scale, as the plurality of domains 212 may be smaller than those shown and may be distributed not only at the surface, but within/throughout the bulk of the continuous phase 204. In certain aspects, the plurality of domains 212 is substantially evenly or homogeneously distributed within the continuous phase 204.

One of the continuous phase 204 and the discrete phase 206 includes a fluorinated material, also referred to as a first chemistry. The other of the continuous phase 204 and the discrete phase 206 includes an immiscible fluorine-free material, also referred to as an immiscible second chemistry. A miscible material, such as a miscible polymeric material, is one that is capable of being intermixed with another distinct material on the molecular scale, while a substantially immiscible material cannot be intermixed or distributed into another distinct material, but instead forms distinct phases, layers, incursions such as domains from the main material, without additional manipulation or reaction within the matrix.

The fluorinated material is a fluorine-containing polymer material, also referred to as a fluorinated polymer, formed from a fluorine-containing precursor having a functionality of greater than 2. The fluorine-containing precursor, also referred to as a fluorinated oligomer, is substantially immiscible with the fluorine-free material. In the highly crosslinked versions, the fluorinated polymer is usually the continuous phase. By a functionality of greater than 2, it is meant that each single precursor molecule has an average of greater than 2 functional groups, such as a hydroxyl group or other functional groups that react to form a crosslinked fluorine-containing polymer network.

At least a portion of the fluorine-free material is bonded together with an isocyanate-containing moiety. “Isocyanate” is the functional group with the formula —N═C═O. For the purposes of this disclosure, S—C(═O)—N(H)—R is considered a derivative of isocyanate.

In the non-limiting example shown in FIG. 2, the fluorinated polymer defines the continuous phase. The fluorinated polymer inhibits the wetting and infiltration of water, while the immiscible fluorine-free material defines the discrete phase, and it acts as a solid anti-freeze for ice. The fluorinated polymer and fluorine-free material are held together by multifunctional isocyanates and the fluorinated polymer is crosslinked with molecules with 4 or more functional groups. The crosslinking molecule with at least 4 functional groups includes a nitrogen-containing moiety, an oxygen-containing moiety, and a combination thereof. It should be appreciated that the fluorinated polymer can be one of the discrete phase and the continuous phase in the biphasic polymer, and the immiscible fluorine-free material can be the other of the discrete phase and the continuous phase.

Both the continuous phase and the discrete phase are in the size of nanometers (nm) on the surface. Ice is formed in the size of millimeters (mm) or larger drops/sheets. The continuous and discrete phases of the coating are significantly smaller than the ice so both the fluorinated polymer and the fluorine-free material act on the ice. The fluorinated polymer stops water from wetting and also reduces the adhesion of ice on the surface. The fluorine-free material is a fluorine-free hygroscopic material and/or hydrophilic material. A hygroscopic material is a material that is able to absorb or adsorb water from its surroundings. A hydrophilic material is a material that has an affinity to water. In a non-limiting exemplary embodiment, the fluorine-free material is a poly(ethylene glycol), also known as PEG, that acts as a solid anti-freeze. The PEG mixes with water molecules in contact with the surface and frustrates their crystallization into ice. By inhibiting ice formation, a liquid water layer is maintained at the surface and the liquid water layer drastically reduces the adhesion of ice.

The fluorinated polymer is a low surface energy material that inhibits wetting and adhesion while the fluorine-free hygroscopic or hydrophilic material breaks up the contact line of ice along the surface. Low surface energy materials are understood to have a surface tension or energy of less than or equal to about 50 mJ/m².

(I) The low surface energy fluorinated polymer, the first chemistry, is a fluoropolymer with functionality greater than two (2) such as fluorinated polyols, perfluorocarbons, perfluoropolyethers, polyfluoroacrylates, polyfluorosiloxanes, polyvinylidene fluoride, polytrifluoroethlylene, polytetrafluoroethylene and copolymers of these materials. These fluoropolymers have hydroxyl or amine functional groups. Polytetrafluoroethylene with pendant hydroxyl groups is an exemplary embodiment.

(II) The fluorine-free material, the secondary chemistry, is not miscible with the fluoropolymer and it is a material such as poly(acrylic acid), a poly(ethylene glycol), poly(2-hydroxyethyl methacrylate), poly(vinyl imidazole), poly(2-methyl-2-oxazoline), poly(2-ethyl-2-oxazoline), poly(vinylpyrolidone), and modified cellulosic polymers including: carboxymethyl cellulose, hydroxyethyl cellulose, hydroxypropyl cellulose, and methyl cellulose. The secondary chemistry has hydroxyl or amine functional groups. Poly(ethylene glycol) is an exemplary embodiment.

(III) An isocyanate is added to bond the first and second chemistries covalently. The reactive agent is selected from the group consisting of polyisocyanate, hexamethylene diisocyanate based monomers, isophorone diisocyanate based monomers, methylene diphenyl diisocyanate based monomers, toluene diisocyanate based monomers, blocked isocyanate monomers, and a combination thereof.

(IV) A crosslinking group with a functionality of 4 or more is added with hydroxyl or amine reactive groups. This may include crosslinkers based on pentaerythritol, triglycerol, di(trimethylolpropane), or combinations thereof. Pentaerythritol propoxylate is an exemplary embodiment.

(V) An ionic species or ionic polyol is optionally added. At least one ionic species is selected from the group consisting of (2,2-bis-(1-(1-methyl imidazolium)-methylpropane-1,3-diol bromide), 1,2-bis(2′-hydroxyethyl)imidazolium bromide, (3-hydroxy-2-(hydroxymethyl)-2-methylpropyl)-3-methyl-1H-3λ4-imidazol-1-ium bromide, 2,2-bis(hydroxymethyl)butyric acid, N,N-bis(2-hydroxyethyl)-2-aminoethanesulfonic acid, N-methyl-2,2′-iminodiethanol, 3-dimethylamino-1,2-propanediol, 2,2-bis(hydroxymethyl)propionic acid, 1,4-bis(2-hydroxyethyl)piperazine, 2,6-diaminocaproic acid, N,N-bis(2-hydroxyethyl)glycine, 2-hydroxypropanoic acid hemicalsium salt, dimethylolpropionic acid, N-methyldiethanolamine, N-ethyldiethanolamine, N-propyldiethanolamine, N-benzyldiethanolamine, N-t-butyldiethanolamine, bis(2-hydroxyethyl) benzylamine, bis(2-hydroxypropyl) aniline. 2,2-bis(hydroxymethyl)propionic acid (DMPA) is an exemplary embodiment.

The at least one ionic species is polymerized by the isocyanate-containing moiety at the same time as both the fluorine-containing polymer and the fluorine-free hygroscopic or hydrophilic material, thus the at least one ionic species is between the fluorine-containing polymer and the fluorine-free hygroscopic or hydrophilic material. The at least one ionic species can also polymerize within the hydroscopic or hydrophilic region. The at least one ionic species won't go in the fluorinated region because it is insoluble with the fluorine-containing polymer.

The additions of stabilizers directly to the polymers can help prevent oxidation, polymer chain scissions, and crosslinking reactions caused by UV exposure or high temperatures. Anti-oxidants can be added to minimize or terminate oxidation caused by UV or heat. Hindered amines stabilizers are efficient for resisting light-induced degradation. Phenyl groups may be added in the chain or at the chain ends to increase thermal stability. These materials can also be combined with one or more additional materials such as a particulate filler, a pigment, a dye, a plasticizer, a flame retardant, a flattening agent, and adhesion promoters. The particulate fillers may be selected from, but not limited to, the group including silica, alumina, silicates, talc, aluminosilicates, barium sulfate, mica, diatomite, calcium carbonate, calcium sulfate, carbon, wollastonite, and combinations thereof; and wherein the particulate filler is optionally surface-modified with a compound selected from the group consisting of fatty acids, silanes, alkylsilanes, fluoroalkylsilanes, silicones, alkyl phosphonates, alkyl phosphonic acids, alkyl carboxylates, alkyldisilazanes, and combinations thereof. Additional additives may be incorporated to alter the appearance of the coating. Colloidal silica may be added at 0.5-5 weight percent (wt. %) to reduce gloss.

The anti-icing coating may be applied as a solution by drop cast, spray, roll coat, and the like, to the intended surfaces. The solvent is allowed to evaporate forming coating with self-cleaning and easy clean properties. Various exterior surfaces of vehicles may be coated with the biphasic anti-icing coating of the present disclosure to have increased ice resistance and cleanability. The coatings may be applied to a variety of surfaces, including a surface of a material selected from the group consisting of plastic, glass, painted surface, metal, and a combination thereof.

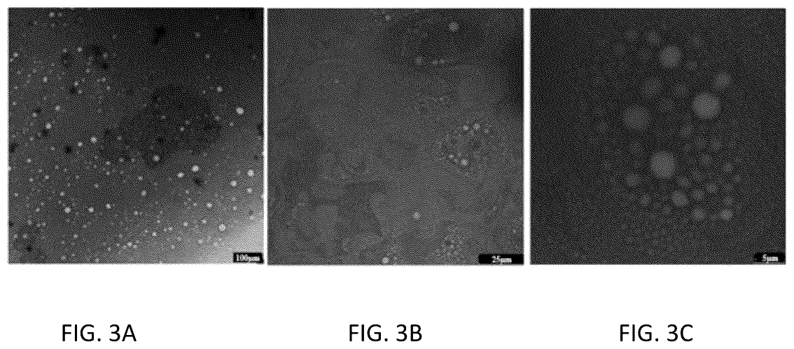

FIGS. 3A-3C are laser scanning confocal microscope images of the biphasic anti-icing coating having a branched fluorinated polymer in the continuous phase and a poly(ethylene glycol) in the discrete phase. FIG. 3A is shown at a magnification level with a 100 μm scale bar, FIG. 3B with a 25 μm scale bar, and FIG. 3C with a 5 μm scale bar. The biphasic anti-icing coating was soaked with a fluorescent dye that preferentially goes into polyethylene glycol areas (domains). The film was then imaged using laser scanning confocal microscope. The sample was excited with an Argon laser which excites the dye and causes the dye to fluoresce. The more fluorescent areas, the lighter areas, represent areas rich in polyethylene glycol. FIGS. 3A-3C confirm discreet areas of the secondary chemistry phase separated from the high fluorine rich areas.

Although vehicle applications are generally discussed, the biphasic anti-icing coating may also be used in other applications such as other vehicle applications (e.g., motorcycles and recreational vehicles), in the aerospace industry (e.g., airplanes, helicopters, drones), nautical applications (e.g., ships, personal watercraft, docks), agricultural equipment, industrial equipment, and the like, including building gutters and anti-ice coatings on sidewalks and walkways.

A method of treating an article is provided by the present disclosure. The article may include an external sensor such as LIDAR sensor or ultrasonic sensor, a glass panel, a plastic component, a painted surface, a metallic panel, and equivalents and combinations thereof. The method includes (a) obtaining a substrate such as a sensor, body component, or panel; (b) optionally applying an adhesion layer or primer to an intended surface of the substrate; (c) forming a polymer solution by combining precursors of the first chemistry and the second chemistry and diluting the combined precursors with a solvent to concentrations ranging from 5% to 60% by weight percent of the solids including the polymer components, and fillers. Typical solvents include MEK, MIBK, xylenes, butyl acetate, and toluene; (d) spraying the polymer solution onto the intended surface of the substrate; and (e) heating to cure the coating or cure at room temperature.

Possible adhesion promoters include:
a. Alkoxysilanes that create chemical groups on a surface that bond to polyols or isocyanates such as (3-Glycidyloxypropyl)trimethoxysilane (GPTMS), (3-Aminopropyl) triethoxysilane (APS), (3-Aminopropyl) triethoxysilane (APS) with (3,3,3-Trifluoropropyl) trimethoxysilane (FPTS), or (3-Aminopropyl) triethoxysilane (APS) with Trimethoxyphenylsilane (TMPS).
b. Epoxy or polyurethane organic primer paints.
c. Adding a third polymer block into the polymer that physiabsorbs onto specific surfaces. For example, polyurethanes hydrogen bond with polyester and nylon surfaces.

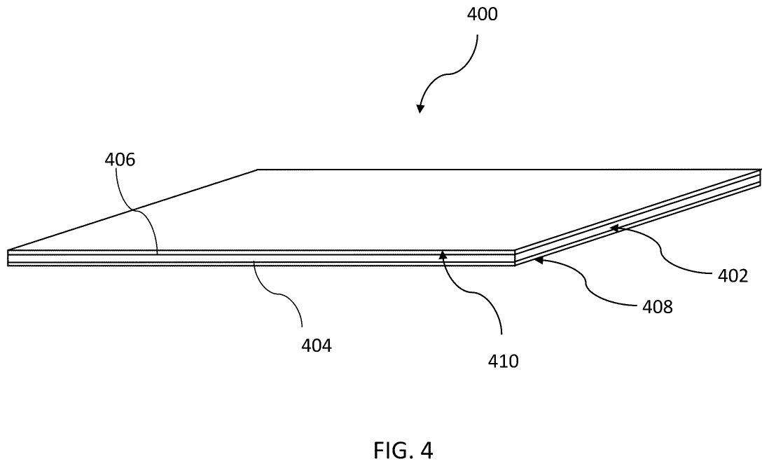

Another method of treating an article is provided by the present disclosure. Referring to FIG. 4, the anti-icing coating may be made into an applique 400. The polymer film 402 includes an interior surface 404 and an exterior surface 406 opposite the interior surface 404. The polymer film 402 can include non-fluorinated polymers or fluorinated polymers. Fluoropolymer films include Teflon FEP, Teflon PFA, Teflon AF, NEOFLON™ EFEP, or PVDF. The interior surface 404 may be treated for adhesion, meaning the interior surface 404 is ozone treated, corona treated, chemically etched, or plasma treated. An adhesive layer 408 is applied to treated interior surface 404. The anti-icing coating 410 of the instant disclosure is applied onto the exterior surface 406 and cured.

The adhesive layer 408 can be a hot melt adhesive, chemical cure adhesive (epoxy-amine), or a pressure sensitive adhesive. A pressure sensitive adhesive is defined herein to designate a distinct category of adhesive material that in a dry form (e.g., substantially free of both solvent and water) are aggressively and permanently tacky at room temperature and that firmly adhere to a variety of dissimilar surfaces at room temperature, including paper, plastic, glass, wood, cement, and metal, upon mere contact without the need of more than 20 pounds per square inch of pressure being applied. These products require no activation by water, solvent, or heat in order to exert a strong adhesive holding force toward such materials. They have sufficient cohesive holding power and an elastic nature so that despite their aggressive tackiness, they can be managed with the fingers and removed from smooth surfaces without leaving a significant residue.

The pressure sensitive adhesive can comprise linear or branched, random or block polymers having one, two, three or more monomer units. Example pressure sensitive adhesives can comprise a material chosen from the adhesives of acrylic resin, polyurethane, rubber, styrene-butadiene-styrene copolymers, ethylene vinyl acetate, styrene block copolymers, and combinations thereof, such as Styrene-ethylene/butylene-styrene (SEBS) block copolymer, Styrene-ethylene/propylene (SEP) block copolymer, Styrene-isoprene-styrene (SIS) block copolymer, or combinations thereof.

Comparative Example 1: Example 1 is a biphasic polymer with a branched fluorinated polymer, a poly(ethylene glycol) anti-freeze phase, a 4, 4′-methylenebis(cyclohexyl isocyanate) isocyanate, and a three reactive group crosslinker (trimethylolpropane).

Example 1, 4-armed crosslinker: A biphasic polymer with a branched fluorinated polymer, a poly(ethylene glycol) anti-freeze phase, a 4, 4′-methylenebis(cyclohexyl isocyanate) isocyanate, a four reactive group crosslinker (pentaerythritol propoxylate). To prepare, a container was charged with Zeffle GK-570 (3.08 g), poly(ethylene glycol) (0.99 g), pentaerythritol propoxylate (0.96 g), and 2-butanone (7.79 g). The solution was mixed until homogenous. 4, 4′-methylenebis(cyclcohexyl isocyanate) (2.77 g) and dibutyltin dilaurate (6.3 μL) were added and mixed until homogenous. The resulting solution was used for spray application.

Example 2, 4-armed crosslinker and adding charged species: A biphasic polymer with a branched fluorinated polymer, a poly(ethylene glycol) anti-freeze phase, a 4, 4′-methylenebis(cyclohexyl isocyanate) isocyanate, a four reactive group crosslinker (pentaerythritol propoxylate), and ionic species (DMPA). To prepare, a container was charged with Zeffle GK-570 (3.08 g), poly(ethylene glycol) (0.99 g), pentaerythritol propoxylate (0.96 g), DMPA (0.03 g), trimethylamine (0.02 g), and 2-butanone (7.90 g). The solution was mixed until homogenous with all solids dissolved. 4, 4′-methylenebis(cyclohexyl isocyanate) (2.83 g) and dibutyltin dilaurate (3.7 μL) were added and mixed until homogeneous. The resulting solution was used for spray application.

The resistance to solvent of the polymers were compared to understand if full curing had occurred and if the coatings would resist solvents during their lifetime. A solvent resistance test method was used, which comprises curing a coating, wiping it with a solvent-soaked fabric, and inspecting the coating for marring or solvent damage. The coatings are rated on a 0 to 5 scale where 0 is no change and 5 is complete debonding. Methyl Ethyl Ketone (MEK) was used as a solvent because it is the solvent for the liquid formulation of this coating. The ratings are shown in Table 1. The addition of the crosslinker with four reactive groups eliminated solvent damage.

TABLE 1
Resistance to solvent damage

| Sample | Observation Score |
|---|---|
| Example 1 | 1 (Slight: Barely Observable Haze) |
| Example 2 | 0 (No Change) |
| Comparative example 1 | 3 (Moderate: Noticeable Haze, Tackiness) |

The Example 1, Example 2, and Comparative example 1 were applied on ultrasonic back-up sensors. The sensors were masked using a combination of painters' tape and parafilm to limit coating application to the barrel of the sensor. A silane solution was prepared from 2% (3-glycidoxypropyl)trimethoxysilane (GPTMS) in 95% ethanol and 5% water. This silane solution was sprayed onto the sensor at about 0.5 mil thickness (wet) and allowed to dry. An aerospace primer (PRC-DeSoto CA7502) was sprayed on top according to the manufacturer's instructions. The Example coatings were sprayed onto the respective sensor barrels in 3 separate coats. The masking was removed and the sensors were cured in an oven for 4 hours at 65° C. The resulting coatings were approximately 1.5 mils thick when dry.

The sensors were installed in a vehicle, the vehicle was placed in a cold chamber, the temperature was reduced to −10° C., water was sprayed on a sensor, and the sensor was checked for operability. The spraying of water and checking for sensor operability were repeated until the sensor failed. The process of spraying water on the sensor and then checking for sensor operability counts as one cycle. The number of cycles until sensor failure were counted and are shown in Table 2. An uncoated sensor was used as a control. Multiple numbers indicate retesting the sensor after it was thawed. As shown in Table 2, Example 1 and Example 2 best resisted immobilization of the sensor from water freezing.

TABLE 2
Cycles until sensor failure.

| Sample | Freezing cycles before failure. |
|---|---|
| Control - uncoated sensor | 5, 2, 7 |
| Example 1 | 12, 11 |
| Example 2 | 11, 11 |
| Comparative Example 1 | 5, 2, 11 |

The description of the present disclosure is merely exemplary in nature and variations that do not depart from the general sense of the present disclosure are intended to be within the scope of the present disclosure. Such variations are not to be regarded as a departure from the spirit and scope of the present disclosure.

What is claimed is:

1. An anti-icing coating, comprising:
a continuous phase comprising a first material;
a plurality of domains comprising a second material, wherein the plurality of domains are dispersed within the continuous phase and are immersible with the continuous phase;
wherein one of the first material and the second material comprises a fluorine-containing polymer formed from a fluorine-containing precursor having a functionality of greater than 2;
wherein the other of the first material and the second material comprises a fluorine-free material, wherein the fluorine-free material includes at least one of a hygroscopic material and a hydrophilic material;
wherein at least a portion of the fluorine-free material is bonded to the fluorine-containing polymer with an isocyanate-containing moiety; and
wherein the fluorine-containing polymer is crosslinked with a crosslinking molecule having at least 4 functional groups including a nitrogen-containing moiety, an oxygen-containing moiety, and a combination thereof.

2. The anti-icing coating of claim 1, wherein:
the first material comprises the fluorine-containing polymer; and
the second material comprises the fluorine-free material.

3. The anti-icing coating of claim 2, wherein the fluorine-free material comprises at least one of a poly(acrylic acid), a poly(ethylene glycol), a poly(2-hydroxyethyl methacrylate), a poly(vinyl imidazole), a poly(2-methyl-2-oxazoline), a poly(2-ethyl-2-oxazoline), a poly(vinylpyrolidone), and a modified cellulosic polymers including at least one of a carboxymethyl cellulose, a hydroxyethyl cellulose, a hydroxypropyl cellulose, and a methyl cellulose.

4. The anti-icing coating of claim 2, wherein the fluorine-free material is a poly(ethylene glycol).

5. The anti-icing coating of claim 2, wherein the fluorine-containing polymer comprises at least one of a fluorinated polyol, a perfluorocarbon, a perfluoropolyether, polyfluoroacrylate, polyfluorosiloxane, a polyvinylidene fluoride, a polytrifluoroethlylene, a polytetrafluoroethylene, and copolymers thereof.

6. The anti-icing coating of claim 2, wherein the fluorine-containing precursor includes at least one of a hydroxyl and amine functional groups.

7. The anti-icing coating of claim 2, wherein the fluorine-containing precursor is a polytetrafluoroethylene having a plurality of pendant hydroxyl groups.

8. The anti-icing coating of claim 2, further comprising at least one ionic species selected from the group consisting of (2,2-bis-(1-(1-methyl imidazolium)-methylpropane-1,3-diol bromide), 1,2-bis(2′-hydroxyethyl)imidazolium bromide, (3-hydroxy-2-(hydroxymethyl)-2-methylpropyl)-3-methyl-1H-3λ4-imidazol-1-ium bromide, 2,2-bis(hydroxymethyl)butyric acid, N,N-bis(2-hydroxyethyl)-2-aminoethanesulfonic acid, N-methyl-2,2′-iminodiethanol, 3-dimethylamino-1,2-propanediol, 2,2-bis(hydroxymethyl)propionic acid, 1,4-bis(2-hydroxyethyl)piperazine, 2,6-diaminocaproic acid, N,N-bis(2-hydroxyethyl)glycine, 2-hydroxypropanoic acid hemicalsium salt, dimethylolpropionic acid, N-methyldiethanolamine, N-ethyldiethanolamine, N-propyldiethanolamine, N-benzyldiethanolamine, N-t-butyldiethanolamine, bis(2-hydroxyethyl) benzylamine, and bis(2-hydroxypropyl) aniline.

9. The anti-icing coating of claim 2, further comprising at least one ionic species polymerized by the isocyanate-containing moiety at the same time as both the fluorine-containing polymer and the fluorine-free material, thus the at least one ionic species is between the fluorine-containing polymer.

10. The anti-icing coating of claim 1, wherein the plurality of domains has an average size of greater than or equal to about 100 nm to less than or equal to about 5,000 nm.

11. An anti-icing coated applique, comprising:
a polymer film having an external surface and an internal surface opposite the external surface;
a pressure sensitive adhesive applied to the internal surface;
an anti-icing coating applied to the external surface, wherein the anti-icing coating comprises:
a continuous phase comprising a fluorine-containing polymer formed from a fluorine-containing precursor having a functionality of greater than 2;
a plurality of domains comprising a fluorine-free material, wherein the plurality of domains are dispersed within the continuous phase and are immiscible with the fluorine-containing polymer; and
a crosslinking molecule with 4 or more functional groups bonding a portion of the fluorine-containing polymer to a portion of the fluorine-free material through at least one of a di-isocyanate containing moiety and a tri-isocyanate containing moiety; and
wherein the fluorine-free material includes at least one of a hygroscopic material and a hydrophilic material.

12. The anti-icing coated applique of claim 11, wherein the crosslinking molecule comprises a nitrogen-containing moiety, an oxygen-containing moiety, and a combination thereof.

13. The anti-icing coated applique of claim 12, wherein the crosslinking molecule is a pentaerythritol propoxylate.

14. The anti-icing coated applique of claim 12, wherein the anti-icing coating further comprises 0.5-5 wt. % of colloidal silica.

15. The anti-icing coated applique of claim 12, wherein the anti-icing coating further comprises at least one of an antioxidant, a hindered amine stabilizer.

16. An anti-icing coating for a vehicle component, comprising:
a continuous phase comprising a fluorine-containing polymer formed from a fluorine-containing precursor having a functionality of greater than 2;
a plurality of domains comprising a fluorine-free material, wherein the plurality of domains are dispersed within the continuous phase and are immersible with the continuous phase;
wherein at least a portion of the fluorine-free material is bonded to the fluorine-containing polymer with an isocyanate-containing moiety; and
wherein the fluorine-containing polymer is crosslinked with a crosslinking molecule having at least 4 functional groups including a nitrogen-containing moiety, an oxygen-containing moiety, and a combination thereof.

17. The anti-icing coating of claim 16, wherein the fluorine-containing precursor comprises at least one of a fluorinated polyol, a perfluorocarbon, a perfluoropolyether, a polyfluoroacrylate, a polyfluorosiloxane, a polyvinylidene fluoride, a polytrifluoroethlylene, and a polytetrafluoroethylene.

18. The anti-icing coating of claim 17, wherein the fluorine-free material comprises at least one of a poly(acrylic acid), a poly(ethylene glycol), a poly(2-hydroxyethyl methacrylate), a poly(vinyl imidazole), a poly(2-methyl-2-oxazoline), a poly(2-ethyl-2-oxazoline), a poly(vinylpyrolidone), and a modified cellulosic polymer including at least one of a carboxymethyl cellulose, a hydroxyethyl cellulose, a hydroxypropyl cellulose, and a methyl cellulose.

19. The anti-icing coating of claim 17, wherein the fluorine-free material is a poly(ethylene glycol).

20. The anti-icing coating of claim 17, wherein the anti-icing coating is applied on an exterior surface of the vehicle component.
